(19) United States
(12) Patent Application Publication
(10) Pub. No.: US 2008/0308972 A1
(43) Pub. Date: Dec. 18, 2008

(54) Process for Preparing Composites Using Epoxy Resin Formulations

(76) Inventor: Alain Fanget, Wollerau (CH)

Correspondence Address: The Dow Chemical Company;Gary C. Cohn, P. O. Box 313, Huntingdon Valley, PA, 19006, US

(21) Appl. No.: 12/134,304

(22) Filed: Jun. 6, 2008

Related U.S. Application Data
(60) Provisional application No. 60/934,756, filed on Jun. 15, 2007.

(51) Int. Cl. B29C 45/00; B29C 39/00

(52) U.S. Cl. 264/328.1; 264/299; 264/331.12

(57) ABSTRACT

The invention is a process for making reinforced composites using an epoxy resin composition. The epoxy resin compositions are hardened using a gem-di(cyclohexylamine)-substituted alkane as a hardener and a tertiary amine compound, a heat-activated catalyst, or a mixture thereof as an accelerator. This epoxy resin composition has a long open time, and then cures rapidly in a mold in the presence of a reinforcement. These cure characteristics make the composition well suited for use in manufacturing processes such as resin transfer molding (RTM), vacuum-assisted resin transfer molding (VARTM), Seeman Composites Resin Infusion Molding Process (SCRIMP) and reaction injection molding (RIM).

### CROSS-REFERENCE TO RELATED APPLICATIONS

This application claims benefit of U.S. Provisional Application No. 60/934,756, filed 15 Jun. 2007.

### BACKGROUND OF THE INVENTION

This invention relates to a process for preparing composites using epoxy resin formulations.

Epoxy resin formulations are used in a number of processes to form reinforced composites. These processes include, for example, molding processes such as those known as resin transfer molding (RTM), vacuum-assisted resin transfer molding (VARTM), Seeman Composites Resin Infusion Molding Process (SCRIMP) and reaction injection molding (RIM) processes. What these processes have in common is that an epoxy resin formulation is applied to a reinforcing agent and cured in the presence of the reinforcing agent. A composite is formed that has a continuous polymer phase (formed from the cured epoxy resin) in which the reinforcing agent is dispersed.

The various processes can be used to produce a wide range of products. The molding processes (such as RTM, VARTM, SCRIMP and RIM) are used to produce high strength parts which are used, for example, in seating, automobile body panels and aircraft components. In the RTM, VARTM, FRI and SCRIMP processes, a woven or matted fiber perform is inserted into a mold cavity. The mold is closed, and the resin is injected into the mold. The resin hardens in the mold to form a composite, and is then demolded. In RIM processes, the reinforcement may be inserted in the mold beforehand as just described, or can be injected into the mold together with the epoxy resin composition.

As is the case with many other manufacturing processes, the economics of these composite manufacturing processes is heavily dependent on operating rates. For molding processes, operating rates are often expressed in terms of “cycle time”. “Cycle time” represents the time required to produce a part on the mold and prepare the mold to make the next part. Cycle time directly affects the number of parts that can be made on a mold per unit time. Longer cycle times increase manufacturing costs because overhead costs (facilities and labor, among others) are greater per part produced. If greater production capacity is needed, capital costs are also increased, due to the need for more molds and other processing equipment. For these reasons, there quite often is a desire to shorten cycle times when possible.

When an epoxy resin is used in the molding processes described above, the predominant component of cycle time is the amount of time required for the resin to cure. Long cure times are often required, especially if the part is large or complex. Therefore, cycle times and production costs can be reduced if the time required for the resin to cure can be shortened.

Faster curing can be promoted through the use of catalysts and, in some cases, highly reactive hardeners. There are other problems associated with faster curing systems such as these. One problem is simply cost, as catalysts and special hardeners tend to be expensive relative to the remainder of the raw materials. In addition, systems which cure more rapidly tend to have short “open times”. “Open time” refers roughly to the time after the components are mixed that it takes for the polymer system to build enough molecular weight and crosslink density that it can no longer flow easily as a liquid, at which time it can no longer be processed using reasonable conditions. Open times are important in composite-manufacturing processes for two main reasons. First, the mixed components must be transferred into the mold or die. This becomes difficult or impossible as viscosity increases with growing polymer molecular weight and crosslink density. Second, the mixed components must be low enough in viscosity that they can flow easily around and between the reinforcement fibers or particles. If the viscosity of the polymer system is too high, it cannot flow easily around the reinforcement, and the resulting composite will have voids or other defects.

The need for an adequate open time becomes increasingly important when making larger parts, because in these cases it can take up to several minutes to fill the mold.

As a result of these problems, there is a need to develop a method for producing composites using an epoxy resin, in which cure time is reduced while preserving an adequate open time, and in which good quality composites are formed.

### SUMMARY OF THE INVENTION

This invention is a process for preparing a molded reinforced composite, comprising introducing an epoxy resin composition and a reinforcement into a mold, and curing the epoxy resin composition in the mold in the presence of a reinforcement, wherein the epoxy resin composition includes at least one epoxy resin, at least one hardener and at least one accelerator compound, wherein the hardener includes a gem-di(cyclohexylamine)-substituted alkane and the accelerator includes a tertiary amine compound, a heat-activated catalyst, or a mixture thereof.

Preferred processes of the invention are RTM, VARTM, RFI, SCRIMP and RIM processes.

In a preferred process of the invention, the epoxy resin contains an average of at least 0.1 hydroxyl group per molecule.

The process of the invention is useful to form various types of composite products, and provides several advantages. Cure times tend to be very short, with good development of polymer properties such as T_{g}. This allows for faster demold times and shorter cycle times. During the first stages of cure, the reaction mixture tends to be low enough in viscosity that it can be transferred easily into the mold or resin bath, where it readily flows around the reinforcing particles or fibers to produce a product having few voids. The slower build-up of viscosity permits lower operating pressures to be used. In some cases, the lower viscosity during early stages of cure can allow lower shot weights to be used, resulting in a savings in raw material cost, and can result in an improvement in the surface characteristics of the composite. Because of these advantages, the process of the invention is useful for producing a wide variety of composite products, of which automotive and aerospace components are notable examples.

### DETAILED DESCRIPTION OF THE INVENTION

The epoxy resin used herein includes at least one compound or mixture of compounds having an average functionality of at least 2.0 epoxide groups per molecule. The epoxy resin or mixture thereof may have an average of up to 4.0 epoxide groups per molecule. It preferably has an average of from 2.0 to 3.0 epoxide groups per molecule.

The epoxy resin may have an epoxy equivalent weight of about 150 to about 1,000, preferably about 160 to about 300, more preferably from about 170 to about 250. If the epoxy resin is halogenated, the equivalent weight may be somewhat higher.

The epoxy resin should have a melting temperature of no greater than 80° C., preferably no greater than 50° C. The epoxy resin may be a liquid at room temperature (˜23° C.).

Suitable epoxy resins include, for example, the diglycidyl ethers of polyhydric phenol compounds such as resorcinol, catechol, hydroquinone, bisphenol, bisphenol A, bisphenol AP (1,1-bis(4-hydroxylphenyl)-1-phenyl ethane), bisphenol F, bisphenol K and tetramethylbiphenol; diglycidyl ethers of aliphatic glycols and polyether glycols such as the diglycidyl ethers of C₂₋₂₄ alkylene glycols and poly(ethylene oxide) or poly(propylene oxide) glycols; polyglycidyl ethers of phenol-formaldehyde novolac resins; alkyl-substituted phenol-formaldehyde resins (epoxy novalac resins); phenol-hydroxybenzaldehyde resins; cresol-hydroxybenzaldehyde resins; dicyclopentadiene-phenol resins and dicyclopentadiene-substituted phenol resins, and any combination thereof.

Suitable diglycidyl ethers of polyhydric phenols include those represented by structure (I)

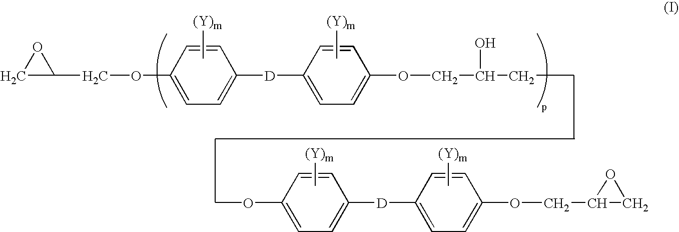

wherein each Y is independently a halogen atom, each D is —S—, —S—S—, —SO—, —SO₂, —CO₃— —CO—, —O— or a divalent hydrocarbon group suitably having from 1 to about 10, preferably from 1 to about 5, more preferably from 1 to about 3 carbon atoms. Each m may be 0, 1, 2, 3 or 4 and p is a number from 0 to 5. p corresponds to the average number of hydroxyl groups present per molecule of an epoxy resin of structure I. Examples of suitable epoxy resins include diglycidyl ethers of dihydric phenols such as bisphenol A, bisphenol K, bisphenol F, bisphenol S and bisphenol AD, and mixtures thereof. Preferred epoxy resins of this type are those in which p is at least 0.1, especially those in which p is from 0.1 to 2.5, as those types contain reactive hydroxyl groups which are believed to contribute to rapid molecular weight and crosslink build during cure. Epoxy resins of this type are commercially available, including diglycidyl ethers of bisphenol A resins such as are sold by The Dow Chemical Company under the designations D.E.R™ 317, D.E.R™ 331, D.E.R™ 364, D.E.R™ 383, D.E.R™ 661, D.E.R™ 662, D.E.R™ 664 and D.E.R™ 667 resins.

Bromine-substituted epoxy resins corresponding to structure I (when Y is Br and at least one m is at least 1) are commercially available from The Dow Chemical Company under the trade names D.E.R™ 542 and D.E.R™ 560. Other suitable halogenated epoxy resins are described in, for example, U.S. Pat. Nos. 4,251,594, 4,661,568, 4,710,429, 4,713,137, and 4,868,059, and The Handbook of Epoxy Resins by H. Lee and K. Neville, published in 1967 by McGraw-Hill, New York, all of which are incorporated herein by reference.

Suitable epoxy resins also include a mixture of a diglycidyl ether of a bisphenol corresponding to structure I, with a small quantity of one or more compounds that contains at least 3 epoxide groups per molecule. The mixture may have an average epoxide functionality of from 2.1 to 2.5. An example of a commercially available mixture of this type is D.E.R. 329, available from The Dow Chemical Company.

Commercially available diglycidyl ethers of polyglycols that are useful herein include those sold as D.E.R™ 732 and D.E.R™ 736 by The Dow Chemical Company.

Suitable epoxy novolac resins include cresol-formaldehyde novolac epoxy resins, phenol-formaldehyde novolac epoxy resins and bisphenol A novolac epoxy resins, including those available commercially as D.E.N™ 354, D.E.N™ 431, D.E.N™ 438 and D.E.N™ 439, all from The Dow Chemical Company.

Other suitable epoxy resins are cycloaliphatic epoxides. A cycloaliphatic epoxide includes a saturated carbon ring having an epoxy oxygen bonded to two vicinal atoms in the carbon ring, as illustrated by the following structure II:

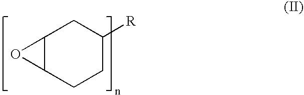

wherein R is an aliphatic, cycloaliphatic and/or aromatic group and n is a number from 1 to 10, preferably from 2 to 4. When n is 1, the cycloaliphatic epoxide is a monoepoxide. Di- or polyepoxides are formed when n is 2 or more. Mixtures of mono-, di- and/or polyepoxides can be used. Cycloaliphatic epoxy resins as described in U.S. Pat. No. 3,686,359, incorporated herein by reference, may be used in the present invention. Cycloaliphatic epoxy resins of particular interest are (3,4-epoxycyclohexyl-methyl)-3,4-epoxy-cyclohexane carboxylate, bis-(3,4-epoxycyclohexyl) adipate, vinylcyclohexene monoxide and mixtures thereof.

Other suitable epoxy resins include tris(glycidyloxyphenyl)methane, tetrakis(glycidyloxyphenyl)ethane, tetraglycidyl diaminodiphenylmethane and mixtures thereof.

Other suitable epoxy resins include oxazolidone-containing compounds as described in U.S. Pat. No. 5,112,932. In addition, an advanced epoxy-isocyanate copolymer such as those sold commercially as D.E.R™ 592 and D.E.R™ 6508 (The Dow Chemical Company) can be used.

The hardener contains at least one gem-di(cyclohexylamine)-substituted alkane, i.e., an alkane or substituted alkane that is substituted at one carbon atom with two cyclohexylamine groups. The cyclohexyl groups are preferably 3- or 4-aminocyclohexyl groups, and the cyclohexyl groups preferably contain no other substitution. Preferred hardeners of this type can be represented by the structure III

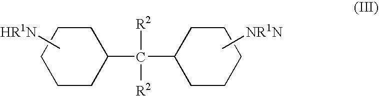

wherein each R² is independently hydrogen, linear or branched alkyl (such as C₁-C₃₀ alkyl, especially C₁-C₂ alkyl), aryl (such as phenyl or substituted phenyl), or substituted alkyl, and each R¹ is independently hydrogen, alkyl or phenyl. The two R² groups may together form a ring. Suitable substituents include inert atoms and groups such as halogen (especially chlorine or bromine), nitro, ether, ester, aryl, alkyl (when R² is phenyl), and the like. Any such substituent is preferably not reactive with an epoxy resin. Each R² is preferably hydrogen or C₁-C₂ alkyl. Each R² is most preferably hydrogen. Each R¹ is preferably hydrogen.

In structure III, the —NR¹H groups are preferably bound to the cyclohexane rings at the 3 or 4 positions, preferably at the 4 positions. The cyclohexane rings are preferably unsubstituted at both positions adjacent to the carbon atom to which the —NR¹H group is attached.

A preferred hardener is bis-(3-aminocyclohexyl)methane and the most preferred hardener is bis-(4-aminocyclohexyl)methane.

Additional hardeners can be used in conjunction with the gem-di(cyclohexylamine)-substituted alkane, but if present at all, these are preferably used in minor amounts. For example, the additional hardener may be used in an amount of up to 50 mole percent of all hardeners, more preferably up to 25 mole percent of all hardeners and even more preferably up to 10 mole percent of all hardeners. A suitable additional hardener is a compound or mixture of compounds having an average of at least 2.0 epoxide-reactive groups per molecule. The additional hardener may have from 2.0 to 4.0 or more epoxide-reactive groups per molecule. The additional hardener preferably has an equivalent weight per epoxide-reactive group of from 30 to 1000, more preferably from 30 to 250 and especially from 30 to 150.

Epoxide-reactive groups are functional groups that will react with a vicinal epoxide to form a covalent bond. These groups include phenol, anhydride, isocyanate, carboxylic acid, amino or carbonate groups. Primary and secondary amino groups are preferred. Amino groups can be aliphatic or aromatic. Aromatic amines are especially preferred.

Suitable aromatic amine hardeners include dicyandiamide, phenylene diamine (particularly the meta-isomer), methylene dianiline, mixtures of methylene dianiline and polymethylene polyaniline compounds (sometimes referred to as PMDA, including commercially available products such as DL-50 from Air Products and Chemicals), diethyltoluenediisocyanate, and diaminodiphenylsulfone.

Suitable aliphatic amine hardeners include ethylene diamine, diethylene triamine, triethylenetetraamine, tetraethylenepentamine, aminoethylpiperazine and amine-epoxy resin adducts, such as are commercially available as D.E.H.™ 52 from The Dow Chemical Company.

Suitable phenolic hardeners include those represented by the structure (IV)

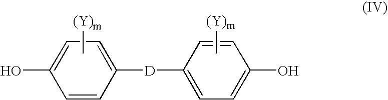

where each Y, m and D are each as described above with regard to structure I. D preferably is a divalent hydrocarbon group as described with regard to structure I above. Examples of suitable phenolic hardeners include dihydric phenols such as bisphenol A, bisphenol K, bisphenol F, bisphenol S and bisphenol AD, and mixtures thereof, and their mono-, di-, tri- and tetra-brominated counterparts.

Phenolic hardeners having three or more phenolic groups, such as tetraphenol ethane, phenol novolacs or bisphenol A novolacs may also be used.

Another useful class of hardeners includes amino-functional polyamides. These are available commercially under as Versamide® 100, 115, 125 and 140, from Henkel, and Ancamide® 100, 220, 260A and 350A, from Air Products and Chemicals.

Suitable anhydride hardeners include, for example, styrene-maleic anhydride copolymers, nadic methyl anhydride, hexahydrophthalic anhydride, methylhexahydrophthalic anhydride, trimellitic anhydride, dodecyl succinic anhydride, phthalic anhydride, methyltetrahydrophthalic anhydride and tetrahydrophthalic anhydride.

Suitable isocyanate hardeners include toluene diisocyanate, methylene diphenyldiisocyanate, hydrogenated toluene diisocyanate, hydrogenated methylene diphenyldiisocyanate, polymethylene polyphenylene polyisocyanates (and mixtures thereof with methylene diphenyldiisocyanate, commonly known as “polymeric MDI”), isophorone diisocyanate, and the like.

Other hardeners that may be used in combination with the gem-di)cyclohexylamine)-substituted alkane are described in U.S. Published Patent Application No. 2004/0101689, incorporated herein by reference.

The epoxy resin composition contains an accelerator. The accelerator includes a tertiary amine compound, a heat-activated catalyst, or a mixture thereof. Other accelerators may be present, but are generally not required and can be omitted.

Tertiary amine accelerators are preferably devoid of amine hydrogens. Suitable tertiary amine accelerators include, for example, trialkyl amines such triethylamine, tripropylamine and tributylamine, as well as aromatic compounds that are substituted with one or more N,N-dialkylaminoalkyl groups. One particularly preferred type of accelerator is a tertiary amine-substituted phenolic compound. It is noted that such compounds have a phenolic hydroxyl group that can react with an epoxide. For this reason, these materials may function both as a hardener and a catalyst. Suitable tertiary amine-substituted phenolic compounds can be represented by structure V:

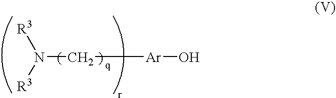

wherein Ar represents an aryl group, preferably a phenyl group; each R³ is independently an alkyl or inertly substituted alkyl group, q is a number from 1 to 12 and r is a number from 1 to 5. Each R³ is preferably ethyl or methyl, most preferably methyl. q is preferably 1, 2 or 3, especially 1 or 2, and r is preferably 1, 2 or 3, especially 2 or 3 and most preferably 3. Examples of compounds falling within structure V include mono- bis- or tris(dimethylaminomethyl)phenol. Tris(dimethylaminomethyl)phenol is a particularly preferred catalyst.

A heat-activated catalyst may be used as an alternative to or in addition to the tertiary amine catalyst. The heat-activated catalyst is a material which has little or no catalytic activity at room temperature (˜23° C.) but which degrades or decomposes at a somewhat higher temperature to generate a catalytic species. The heat-activated catalyst preferably becomes activated at a temperature of from 35° C. to 150° C., more preferably at a temperature of from 50° C. to 100° C., and even more preferably at a temperature of from 50° C. to 90° C. Examples of such heat-activated catalysts include, for example, ethyl-4-toluene sulfonate and propyl-4-toluene sulfonate.

It is possible, but generally less preferred, to include one or more additional accelerators in the epoxy resin composition. Suitable additional accelerators include well-known epoxy curing catalysts such as those are described in, for example, U.S. Pat. Nos. 3,306,872, 3,341,580, 3,379,684, 3,477,990, 3,547,881, 3,637,590, 3,843,605, 3,948,855, 3,956,237, 4,048,141, 4,093,650, 4,131,633, 4,132,706, 4,171,420, 4,177,216, 4,302,574, 4,320,222, 4,358,578, 4,366,295, and 4,389,520, all incorporated herein by reference. Examples of suitable additional accelerators are imidazoles such as 2-methylimidazole, 2-ethyl-4-methylimidazole and 2-phenyl imidazole; phosphonium salts such as ethyltriphenylphosphonium chloride, ethyltriphenylphosphonium bromide and ethyltriphenyl-phosphonium acetate; ammonium salts such as benzyltrimethylammonium chloride and benzyltrimethylammonium hydroxide; and mixtures thereof. If an additional accelerator is used, the amount thereof to be used generally ranges from about 0.001 to about 2 weight percent, but preferably is no greater than about 0.5 weight percent, based on the weight of the epoxy resin.

One preferred embodiment of the epoxy resin composition includes at least one diglycidyl ether of a phenol, which diglycidyl ether contains an average of from 0.1 to 5 hydroxyl groups per molecule, bis-(3-aminocyclohexyl)methane and/or bis-(4-aminocyclohexyl)methane, and at least one tertiary amine-substituted phenolic compound. In other preferred embodiments, the epoxy resin composition includes at least one diglycidyl ether of a bisphenol, which diglycidyl ether contains an average of from 0.1 to 5 hydroxyl groups per molecule, bis-(3-aminocyclohexyl)methane and/or bis-(4-aminocyclohexyl)methane and at least one tertiary amine-substituted phenolic compound, in which the weight ratio of the bis-(3-aminocyclohexyl)methane and/or bis-(4-aminocyclohexyl)methane and the tertiary amine-substituted phenolic compound(s) is from about 94:6 to 80:20. In especially preferred embodiments, the epoxy resin includes a diglycidyl ether of bisphenol A, which contains an average of from 0.1 to 2.5 hydroxyl groups per molecule, bis-(4-aminocyclohexyl)methane and mono-, di- or tri(dimethylaminomethyl)phenol, in which the weight ratio of the bis-(4-aminocyclohexyl)methane and the mono-, bis- or tris(dimethylaminomethyl)phenol compound is from about 94.9:5.1 to 80:20.

Another preferred embodiment of the epoxy resin composition includes at least one diglycidyl ether of a phenol, which diglycidyl ether contains an average of from 0.1 to 5 hydroxyl groups per molecule, bis-(3-aminocyclohexyl)methane and/or bis-(4-aminocyclohexyl)methane, and ethyl-4-toluene sulfonate or propyl-4-toluene sulfonate. In especially preferred embodiments, the epoxy resin includes a diglycidyl ether of bisphenol A, which contains an average of from 0.1 to 2.5 hydroxyl groups per molecule, bis-(4-aminocyclohexyl)methane and ethyl-4-toluene sulfonate.

Another preferred but optional component in the epoxy resin composition is an internal mold release agent. The composition of the internal mold release agent is not particularly critical, and any internal mold release agent that is useful in epoxy resin compositions can in principal be used with this invention. Preferred types of internal mold release agents include various amine salts and esters of fatty acids. Internal mold releases that are designed for epoxy resin applications include those sold by KVS Eckert & Woelk GmbH, Welgesheim, Germany, and by Axel Plastics Research Laboratories, Inc., Woodside, N.Y., USA.

Various optional components can be added into the reaction mixture. These include, for example, one or more solvents or diluents, mineral fillers, pigments, antioxidants, preservatives, impact modifiers, wetting agents and the like.

A solvent may also be used, but again it is preferred to omit this. The solvent is a material in which the epoxy resin, or hardener, or both, are soluble, at the temperature at which the epoxy resin and hardener are mixed. The solvent is not reactive with the epoxy resin(s) or the hardener under the conditions of the polymerization reaction. The solvent (or mixture of solvents, if a mixture is used) preferably has a boiling temperature that is at least equal to and preferably higher than the temperatures employed to conduct the polymerization. Suitable solvents include, for example, glycol ethers such as ethylene glycol methyl ether and propylene glycol monomethyl ether; glycol ether esters such as ethylene glycol monomethyl ether acetate and propylene glycol monomethyl ether acetate; poly(ethylene oxide) ethers and poly(propylene oxide) ethers; polyethylene oxide ether esters and polypropylene oxide ether esters; amides such as N,N-dimethylformamide; aromatic hydrocarbons toluene and xylene; aliphatic hydrocarbons; cyclic ethers; halogenated hydrocarbons; and mixtures thereof.

If used, the solvent may constitute up to 75% of the weight of the reaction mixture, more preferably up to 30% of the weight of the mixture. Even more preferably, the reaction mixture contains no more than 5% by weight of a solvent and most preferably contains no more than 1% by weight of a solvent.

Suitable impact modifiers include natural or synthetic polymers having a T_{g} of lower than −40° C. These include natural rubber, styrene-butadiene rubbers, polybutadiene rubbers, isoprene rubbers, core-shell rubbers, and the like. The rubbers are preferably present in the form of small particles that become dispersed in the polymer phase of the composite. The rubber particles can be dispersed within the epoxy resin or hardener and preheated together with the epoxy resin or hardener prior to forming the hot reaction mixture.

In the process of the invention, an epoxy resin, hardener and accelerator, as well as any optional components as described before, are mixed to form an epoxy resin composition, which then reacts in the presence of a reinforcing agent to form a composite. Various components can be premixed if desired, before bringing all components together and introducing the mixture into the mold. For example, the epoxy resin and accelerators (particularly the heat-activated types) can be formulated together beforehand and then mixed with the hardener at the time of use.

The reaction is performed in a mold. Preferred processes are resin transfer molding processes, including vacuum-assisted resin transfer molding (VARTM) processes, Seemans Composites Resin Infusion Molding Process (SCRIMP) and reaction injection molding processes.

The mixture of epoxy resin composition is introduced into the mold, rapidly enough that the reaction mixture does not become highly viscous or form significant gels before the mold is filled. It is generally preferred to complete the transfer of the reaction mixture to the mold within four minutes of the time the epoxy resin and hardener are first contacted, although any shorter time may be used.

An advantage of this invention is that the epoxy resin composition often has a substantial “open time” (i.e., the time interval after mixing all components together until the mixture becomes too viscous to process). Within the open time, the epoxy resin composition remains fluid enough to be processed easily, and in particular to retain the ability to flow around and between the filaments of a preform or other fibrous reinforcement. Open times with the invention are typically in the order of from 100 to 500 seconds or more.

The slow initial increase in viscosity is a very significant advantage, particularly when very large shot weights (>10 kg, for example) are needed. When very large molds are being filled, it may take several minutes to transfer the resin composition into the mold. If the composition builds viscosity too rapidly, the resin composition becomes quite viscous towards the end of the mold-filling process. As a result, greater operating pressures are needed to force the resin composition into the mold and to force it to flow around the reinforcement in the mold. A certain amount of overpacking is often needed to complete the mold-filling process. With this invention, the open time is typically of the order of 3-4 minutes or even more, which is sufficient to permit even very large molds to be filled. The low viscosity during this period means that lower operating pressures can be used. In some cases, shot weights can be reduced.

Yet another advantage of the long open time is that the mold composite tends to have very good surface characteristics, again due to the low viscosity during the mold-filling process, which allows the resin composition to flow more uniformly to all sections of the mold and to more uniformly wet-out the surface of the mold before it is cured.

The epoxy resin composition may be heated prior to transferring the composition into the mold. This has the advantage of reducing its viscosity somewhat, which favors full wet-out of the reinforcement, but may tend to reduce open time. The individual components (epoxy resin, hardener, etc.) may be heated individually or in subcombinations prior to forming the complete mixture. Alternatively, the fully formulated epoxy resin composition may be heated prior to transfer. A suitable temperature is 35° C. to 160° C., especially from 50 to 90° C., if this heating is performed.

The mixing and transfer apparatus can be of any type that can produce a highly homogeneous mixture of the epoxy resin, hardener and accelerator (and any optional components that are also mixed in at this time). Mechanical mixers and stirrers of various types may be used. Two preferred types of mixers are static mixers and impingement mixers. Impingement mixing is another way of mixing the epoxy resin and hardener. The formulated epoxy resin composition can be transferred to the mold or resin bath using a variety of pumping and transfer equipment. Alternatively, the epoxy resin composition can be sprayed into the mold.

The mold is typically a metal mold, but it may be ceramic or a polymer composite, provided that the mold is capable of withstanding the pressure and temperature conditions of the molding process. The mold contains one or more inlets, in liquid communication with the mixer(s), through which the reaction mixture is introduced. The mold may contain vents to allow gases to escape as the reaction mixture is injected. In vacuum-assisted processes, a vacuum is pulled on the mold prior to injecting the epoxy resin composition.

The mold is typically held in a press or other apparatus which allows it to be opened and closed, and which can apply pressure on the mold to keep it closed during the filling and curing operations.

The reinforcement can take any of several forms, depending on the particular process and product. Continuous, parallel fibers, woven or matted fiber performs, short fibers and even low aspect ratio reinforcing agents can be used in various embodiments of the invention. In molding processes, a particularly suitable reinforcement is a fiber preform. Alternatively, various other types of fibrous reinforcements can be used, including those continuous fiber rovings, cut fibers or chopped fibers. Non-fibrous reinforcements can also be used, but they are generally less preferred, except in some instances in which it is desired to produce a class A automotive surface.

The reinforcing agent is thermally stable and has a high melting temperature, such that the reinforcing agent does not degrade or melt during the molding process. Suitable fiber materials include, for example, glass, quartz, polyamide resins, boron, carbon and gel-spun polyethylene fibers. Non-fibrous reinforcing agents include particulate materials which remain solid under the conditions of the polymerization. They include, for example, glass flakes, aramid particles, carbon black, carbon nanotubes, various clays such as montmorillonite, and other mineral fillers such as wollastonite, talc, mica, titanium dioxide, barium sulfate, calcium carbonate, calcium silicate, flint powder, carborundum, molybdenum silicate, sand, and the like. Wollastonite and mica are preferred reinforcing agents, either by themselves or in conjunction with a fiber reinforcing agent, when producing parts having a high distinctness of image (DOI), such as automotive body parts that require a class A automotive surface.

Some fillers are somewhat electroconductive, and their presence in the composite can increase the electroconductivity of the composite. In some applications, notably automotive applications, it is preferred that the composite is sufficiently electroconductive that coatings can be applied to the composite using so-called “e-coat” methods, in which an electrical charge is applied to the composite and the coating becomes electrostatically attracted to the composite. Conductive fillers of this type include metal particles (such as aluminum and copper) and fibers, carbon black, carbon nanotubes, carbon fibers, graphite and the like.

A preferred type of reinforcement is a fiber preform, i.e., a web or mat of fibers. The fiber preform can be made up of continuous filament mats, in which the continuous filaments are woven, entangled or adhered together to form a preform that approximates the size and shape of the finished composite article (or portion thereof that requires reinforcement). Alternatively, shorter fibers can be formed into a preform through entanglement or adhesive methods. Mats of continuous or shorter fibers can be stacked and pressed together, typically with the aid of a tackifier, to form preforms of various thicknesses, if required.

Suitable adhesives (sometimes known as “tackifiers”) for preparing performs (from either continuous or shorter fibers) include heat-softenable polymers such as described, for example, in U.S. Pat. Nos. 4,992,228, 5,080,851 and 5,698,318. The tackifier should be compatible with and/or react with the polymer phase of the composite, so that there is good adhesion between the polymer and reinforcing fibers. A heat-softenable epoxy resin or mixture thereof with a hardener, as described in U.S. Pat. No. 5,698,318, is especially suitable. The tackifier may contain other components, such as one or more catalysts, a thermoplastic polymer, a rubber, or other modifiers.

Fiber preforms are typically placed into the mold prior to introducing the epoxy resin composition. The epoxy resin composition can be introduced into a closed mold that contains the preform, by injecting the mixture into the mold, where the composition penetrates between the fibers in the preform and then cures to form a composite product. Reaction injection molding and/or resin transfer molding equipment is suitable in such cases. Alternatively, the preform can be deposited into an open mold, and the hot reaction mixture can be sprayed onto the preform and into the mold. After the mold is filled in this manner, the mold is closed and the reaction mixture cured. In either approach, the mold and the preform are preferably heated prior to contacting them with the reaction mixture, in order to maintain the temperature of the reaction mixture as described before.

Short fibers can be used instead or in addition to a fiber preform. Short fibers (up to about 6 inches in length, preferably up to 2 inches in length, more preferably up to about ½ inch in length) can be blended into the epoxy resin composition and injected into the mold with the hot reaction mixture. Such short fibers may be, for example, blended with the epoxy resin or hardener (or both), prior to forming the reaction mixture. Alternatively, the short fibers may be added into the reaction mixture at the same time as the epoxy and hardener are mixed, or afterward but prior to introducing the mixture into the mold.

Short fibers can be sprayed into a mold. In such cases, the epoxy resin composition can also be sprayed into the mold, at the same time as or after the short fibers are sprayed in. When the fibers and epoxy resin composition are sprayed simultaneously, they can be mixed together prior to spraying. Alternatively, the fibers and epoxy resin composition can be sprayed into the mold separately but simultaneously. In a process of particular interest, long fibers are chopped into short lengths and the chopped fibers are sprayed into the mold, at the same time as or immediately before the epoxy resin composition is sprayed in.

Other particulate fillers can be incorporated into the reaction mixture in the same manner as described with respect to the short fibers.

Various types of composite parts can be made by assembling other components into the mold prior to introducing the epoxy resin composition. For example, various types of in-mold coatings can be placed onto one or both mold surfaces to provide certain desired surface characteristics (such as color and/or gloss). Examples of such in-mold coatings include various types of polyester, epoxy and/or polyurethane in-mold coatings. In addition, synthetic leather, vinyl and/or cloth may be inserted into the mold to provide another type of show surface. Reinforcements such as metal plates or rods may be inserted into the mold to provide enhanced physical properties to the composite. Various types of polymer foams may be inserted in the mold for application-specific purposes. In the transportation industry, for example, such foams may provide thermal and/or acoustic insulation. Polymer foams may be thermoplastic (such as polyolefins) or thermoset (such as epoxy or polyurethane) types, and may be open- or closed-celled. The polymer foams may be rigid, semi-rigid or flexible types, depending on the specific application.

Curing is performed in the mold until the polymer phase of the composite has cured sufficiently to form a composite that can be demolded without permanently deforming it. Preferably, curing is continued until the polymer phase attains a T_{g} of at least 120° C., preferably at least 135° C. As it is difficult to measure T_{g} directly within the mold, in most cases the necessary in-mold residence times will be established empirically with respect to a particular reactive system, equipment and curing conditions. The cured polymer is preferably cooled below its glass transition temperature, particularly to at least 25° C. below the glass transition temperature, prior to demolding the composite.

The contents of the mold may be heated in order to obtain a more rapid cure. Temperatures of from 70° C. to 200° C. or more can be used. Preferred temperatures depend somewhat on specific applications, but a preferred mold temperature for many applications is from 75 to 160° C. and more preferably from 80 to 120° C.

The epoxy resin composition of the invention has been found to have a somewhat extended open time, followed by a rapid cure. Despite the prolonged open times, overall curing times tend to be significantly lower than for similar systems that use, for example, an aminoethylpiperazine/isophorone diamine hardening system. Curing times for specific applications will of course depend on various factors such as part size, mold temperatures, the amount of reinforcement present and the like. However, curing times are typically reduced by 20-40% with this invention, compared to those obtained with an aminoethylpiperazine/isophorone diamine hardening system.

The process of the invention is useful to make a wide variety of composite products, including various types of automotive parts. Examples of these automotive parts include vertical and horizontal body panels, automobile and truck chassis components, and so-called “body-in-white” structural components. Other examples include truck tool boxes, truck top-sleepers and the like.

Body panel applications include fenders, door skins, hoods, roof skins, decklids, tailgates, wind deflectors and the like. Body panels often require a surface which has a high distinctness of image (DOI). Another advantage of the invention is that the demolded parts often have excellent surface quality, and require little rework. This is particularly important in these body panel applications. The filler in many body panel applications will include a material such as mica or wollastonite. In addition, these parts are often coated in the so-called “e-coat” process, and for that reason must be somewhat electroconductive. Accordingly, an electroconductive filler as described before may be used in body panel applications to increase the electrical conductivity of the part. An impact modifier as described before may be used in body panel applications to toughen the parts.

Automotive and truck chassis components made in accordance with the invention offer significant weight reductions compared to steel. This advantage is of most significance in large truck applications, in which the weight savings translate into larger vehicle payload. Automotive chassis components provide not only structural strength, but in many cases (such as floor modules) provide vibration and sound abatement. It is common to apply a layer of a dampening material to steel floor modules and other chassis parts to reduce sound and vibration transmission through the part. Such dampening materials can be applied in similar manner to a composite floor module made in accordance with this invention.

As mentioned, the invention provides particular benefits in preparing large moldings, in which shot times tend to be on the order of 1 minute or more, and are often in the range of 2-4 minutes. In these cases, shot weights often exceed 10 kg and may be in the range of 15-50 kg.

The following examples are provided to illustrate the invention, but not limit the scope thereof. All parts and percentages are by weight unless otherwise indicated.

### EXAMPLE 1

100 parts of diglycidyl ether of bisphenol A, corresponding to structure I above in which n is about 0.15 and each m is zero, is blended with 3 parts of a grey pigment and 0.8 parts of an internal mold release agent. This mixture is charged to a resin tank and heated to 70° C. with stirring.

A mixture of 90 parts of bis-(4-aminocyclohexyl)methane and 10 parts of 2,4,6-tris(dimethylaminomethyl)phenol is charged to a tank and heated to 30° C. with stirring.

A 25 micron unsaturated polyester gel-coat (Oldopal-ortho/NPG 717-7838 from BÜFA) is manually sprayed onto the top side of a vented truck wind deflector mold and allowed to dry for about 2 minutes. A pre-formed fiber glass reinforcement mat having a weight of 450 g/m² then positioned manually into the mold, and the mold is closed.

The epoxy resin mixture and the hardener are injected into the mold through a static mixer dispensing unit. Air is removed from upper side vents of the mold. The ratio of epoxy resin mixture to hardener is 100/30. Pouring time is 180 sec. The mold is preheated to 80° C. and maintained at that temperature during the curing process. Demold time is about 22 minutes after end of pouring. The demolded parts exhibit little shrinkage of the part itself or of the cured gel-coat. The parts have excellent surface characteristics. The T_{g} of the polymer phase for a typical part made in this manner is about 140° C. Part thickness is approximately 4 mm.

Similar results are made when the epoxy resin composition is used to make a different style of truck wind deflector. In this case, a 10 mm polyurethane foam core and 2 layers of the glass reinforcing mat described above are placed in the mold, the resin composition is injected and cured as before.

For comparison, additional parts are made using a different epoxy resin composition. The epoxy resin in this case is a diglycidyl ether of bisphenol A, which corresponds to structure I above in which n is less than 0.1 and each m is zero. It is blended with an internal mold release agent and pigment as before. This blend is cured with a 50/50 by weight mixture of aminoethylpiperazine and isophorone diamine. This system cannot be demolded in less than 32 minutes. Typical T_{g} for these parts is 134° C. and surface quality is somewhat inferior.

### EXAMPLE 2

In this example, a truck top-sleeper unit is formed in a reaction injection molding process. The A-side is a diglycidyl ether of bisphenol A as described in Example 1. This mixture is charged to a resin tank and heated to 70° C. with stirring. The B-side is a mixture of 90 parts of bis-(4-aminocyclohexyl)methane and 10 parts of 2,4,6-tris(dimethylaminomethyl)phenol, which is preheated to 30° C. with stirring.

Fiber glass reinforcement mats are positioned manually into a truck top-sleeper mold, and the mold is closed. The epoxy resin mixture and the hardener are injected into the mold using a RIM machine. The shot weight is about 35 kg. The top side of the filled mold is heated to 88° C., and the bottom side is heated to 84° C. Demold time is 23 minutes after end of pouring. The demolded parts exhibit little shrinkage and have excellent surface characteristics. Shore D hardness of the parts at demold is 84-87, which indicates complete crosslinking and good curing.

For comparison, additional parts are made using an epoxy resin that is cured with various mixtures of aminoethylpiperazine and isophorone diamine or 1,2-diaminocyclohexane, aminoethylpiperazine and 1,3-cyclohexanedimethanamine. In some cases, the epoxy resin composition contains 2,4,6-tris(dimethylaminomethyl)phenol. These systems all require about 35 minutes curing time before they can be demolded, whether or not the accelerator is present. In addition, these systems all require a greater shot weight (by about 1500-1800 grams), as these compositions build viscosity quickly during the mold-filling process and more resin must be forced into the mold to wet out the fibers and the mold surfaces completely. The surface characteristics of these parts are clearly inferior to those of the invention, and as a result, more rework of the parts is needed prior to painting.

What is claimed is:

1. A process for preparing a molded reinforced composite, comprising introducing an epoxy resin composition and a reinforcement into a mold, and curing the epoxy resin composition in the mold in the presence of the reinforcement, wherein the epoxy resin composition includes at least one epoxy resin, at least one hardener and at least one accelerator compound, wherein the hardener includes a gem-di(cyclohexylamine)-substituted alkane and the accelerator includes a tertiary amine compound, a heat-activated catalyst, or a mixture thereof.

2. The process of claim 1, wherein the epoxy resin includes a diglycidyl ether of a phenol, which diglycidyl ether contains an average of from 0.1 to 5 hydroxyl groups per molecule, the gem-di(cyclohexylamine)-substituted alkane is bis-(3-aminocyclohexyl)methane, bis-(4-aminocyclohexyl)methane or a mixture thereof, and the accelerator includes at least one tertiary amine-substituted phenolic compound.

3. The process of claim 2 wherein the weight ratio of the bis-(3-aminocyclohexyl)methane, bis-(4-aminocyclohexyl)methane or mixture thereof and the tertiary amine-substituted phenolic compound(s) is from about 94:6 to 80:20.

4. The process of claim 3, wherein the bis-(3-aminocyclohexyl)methane, bis-(4-aminocyclohexyl)methane or mixture thereof is the only hardener present in the epoxy resin composition, and the tertiary amine-substituted phenolic compound(s) are the only accelerators present in the epoxy resin composition.

5. The process of claim 1, wherein the epoxy resin includes a diglycidyl ether of bisphenol A, which diglycidyl ether contains an average of from 0.1 to 2.5 hydroxyl groups per molecule, the gem-di(cyclohexylamine)-substituted alkane is bis-(4-aminocyclohexyl)methane, and the accelerator includes at least one mono-, di- or tri(dimethylaminomethyl)phenol, and further wherein the weight ratio of the bis-(4-aminocyclohexyl)methane and the mono-, bis- or tris(dimethylaminomethyl)phenol compound is from about 94.9:5.1 to 80:20.

6. The process of claim 5, wherein the bis-(4-aminocyclohexyl)methane is the only hardener present in the epoxy resin composition, and the mono-, bis- or tris(dimethylaminomethyl)phenol is the only accelerator present in the epoxy resin composition.

7. The process of claim 1 wherein the epoxy resin includes at least one diglycidyl ether of a phenol, which diglycidyl ether contains an average of from 0.1 to 5 hydroxyl groups per molecule, the hardener includes bis-(3-aminocyclohexyl)methane, bis-(4-aminocyclohexyl)methane or a mixture thereof, and the accelerator includes ethyl-4-toluene sulfonate or propyl-4-toluene sulfonate.

8. The process of claim 7, wherein the bis-(3-aminocyclohexyl)methane, bis-(4-aminocyclohexyl)methane or mixture thereof is the only hardener present in the epoxy resin composition, and the ethyl-4-toluene sulfonate or propyl-4-toluene sulfonate are the only accelerator or accelerators present in the epoxy resin composition.

9. The process of claim 1 wherein the epoxy resin includes a diglycidyl ether of bisphenol A, which contains an average of from 0.1 to 2.5 hydroxyl groups per molecule, the hardener includes bis-(4-aminocyclohexyl)methane and the accelerator includes ethyl-4-toluene sulfonate.

10. The process of claim 9, wherein the bis-(4-aminocyclohexyl)methane is the only hardener present in the epoxy resin composition, and the ethyl-4-toluene sulfonate or propyl-4-toluene sulfonate are the only accelerator or accelerators present in the epoxy resin composition.

11. The process of claim 1 wherein the reinforcement is a fiber.

12. The process of claim 11 which is a resin transfer molding (RTM), vacuum-assisted resin transfer molding (VARTM), Seeman Composites Resin Infusion Molding Process (SCRIMP) or reaction injection molding (RIM) process.

13. The process of claim 12, wherein the epoxy resin composition contains less than 5% by weight of a solvent.
